(19) United States
(12) Patent Application Publication
(10) Pub. No.: US 2025/0220590 A1
(43) Pub. Date: Jul. 3, 2025

(54) USER EQUIPMENT FOR POWER CONSUMPTION REDUCTION AND METHOD OF OPERATING WIRELESS COMMUNICATION SYSTEM INCLUDING THE SAME

(71) Applicant: SAMSUNG ELECTRONICS CO., LTD., SUWON-SI (KR)

(72) Inventors: YOUNGSEOK JUNG, Suwon-si (KR); KYOUNGBAEK MIN, Suwon-si (KR); JUNYEONG SEO, Suwon-si (KR); JANGHO LEE, Suwon-si (KR); HANYOUNG JO, Suwon-si (KR)

(21) Appl. No.: 18/975,206

(22) Filed: Dec. 10, 2024

(30) Foreign Application Priority Data
Dec. 29, 2023 (KR) 10-2023-0197724
Mar. 26, 2024 (KR) 10-2024-0041293

(51) Int. Cl. H04W 52/24; H04B 17/318; H04W 8/22; H04W 52/36

(52) U.S. Cl. CPC H04W 52/241; H04B 17/328; H04W 8/22; H04W 52/367

(57) ABSTRACT

Provided are a user equipment and an operation method of a wireless communication system including the user equipment, the user equipment allowing power consumption of a network (or base station) to be reduced by determining whether internal noise among noise components of the user equipment is a dominant factor, based on capability information of the user equipment, and, when the internal noise is a dominant factor, performing a power adjustment operation that adjusts transmission power of at least one of signals or channels to be transmitted to the user equipment. An operation method of a wireless communication system includes receiving capability information including a determination parameter, determining whether internal noise among noise components of a user equipment is a dominant factor, based on the determination parameter, and, when the internal noise is determined to be a dominant factor, performing a power adjustment operation that adjusts transmission power.

### CROSS-REFERENCE TO RELATED APPLICATIONS

This application claims priority under 35 U.S.C. § 119 to Korean Patent Application No. 10-2023-0197724, filed on Dec. 29, 2023, and Korean Patent Application No. 10-2024-0041293, filed on Mar. 26, 2024, the disclosures of which are incorporated by reference herein in their entireties.

### TECHNICAL FIELD

Embodiments of the inventive concept relate to wireless communication, and more particularly, to a user equipment capable of reducing power consumption, a method of operating a base station, and a method of operating a wireless communication system including the user equipment and the base station.

### DISCUSSION OF RELATED ART

Recently, 5G (or new radio (NR)) communication systems have achieved high carrier frequencies, an increase in frequency bandwidths, increased numbers of transmission-and-reception antennas and networks (or base stations) to provide several-Gbps ultrahigh speed data services by using, as a new radio access technology, an ultra-wideband having bandwidths of 100 MHz or more as compared with existing long term evolution (LTE) and LTE-Advanced (LTE-A). Rapidly increasing data capacities may give rise to an increase in power consumption of networks (or base stations).

### SUMMARY

Embodiments of the inventive concept provide a user equipment and a method of operating a wireless communication system including the user equipment, the user equipment allowing power consumption of a network (or a base station) to be reduced by determining whether internal noise among noise components of the user equipment is a dominant factor, based on capability information of the user equipment, and performing a power adjustment operation for adjusting transmission power of at least one of a signal or a channel to be transmitted to the user equipment when the internal noise is a dominant factor.

According to an embodiment of the inventive concept, there is provided a method of operating a wireless communication system including a base station and at least one user equipment communicating with the base station. The method includes receiving, by the base station, capability information including a determination parameter from the at least one user equipment, determining, by the base station, whether an internal noise among noise components of the at least one user equipment is a dominant factor, based on the determination parameter, and, when the internal noise is determined to be a dominant factor, performing, by the base station, a power adjustment operation that adjusts a transmission power of at least one of a signal or a channel to be transmitted to the at least one user equipment.

According to an embodiment of the inventive concept, there is provided a method of operating a base station communicating with at least one user equipment. The method includes receiving, from the at least one user equipment, capability information including a determination parameter and power adjustment operation-related information, requesting information corresponding to the determination parameter from the at least one user equipment, based on the capability information, receiving the information corresponding to the determination parameter, determining whether an internal noise among noise components of the at least one user equipment is a dominant factor, based on the determination parameter and the information corresponding to the determination parameter, and, when the internal noise is determined to be a dominant factor, performing a power adjustment operation that adjusts a transmission power of at least one of a signal or a channel to be transmitted to the at least one user equipment.

According to an embodiment of the inventive concept, there is provided a user equipment configured to perform wireless communication with a base station. The user equipment includes a plurality of antennas, and a processing circuit configured to determine whether an internal noise among noise components of the user equipment is a dominant factor, based on a determination parameter, and, when the internal noise is determined to be a dominant factor, generate capability information including power adjustment operation request information.

### BRIEF DESCRIPTION OF THE DRAWINGS

The above and other features of the present inventive concept will become more apparent by describing in detail embodiments thereof with reference to the accompanying drawings, in which:

FIG. 1 is a block diagram illustrating a wireless communication system according to an embodiment;

FIG. 2 is a flowchart illustrating a method of operating a wireless communication system, according to an embodiment;

FIG. 3 is a flowchart illustrating a method of operating a wireless communication system, according to an embodiment;

FIG. 4 is a flowchart illustrating a power adjustment operation of a wireless communication system, according to an embodiment;

FIG. 5 is a flowchart illustrating an implementation example of determining a transmission gain of a wireless communication system, according to an embodiment;

FIG. 6 is a flowchart illustrating an implementation example of a power adjustment operation of a wireless communication system, according to an embodiment;

FIG. 7 is a block diagram illustrating a base station of a wireless communication system, according to an embodiment;

FIG. 8 is a block diagram illustrating a user equipment of a wireless communication system, according to an embodiment;

FIG. 9 is a flowchart illustrating a method of operating a wireless communication system, according to an embodiment;

FIG. 10 is a block diagram illustrating an electronic device according to an embodiment; and

FIG. 11 is a conceptual diagram illustrating an Internet-of-Things (IoT) network system to which an embodiment is applied.

### DETAILED DESCRIPTION OF THE EMBODIMENTS

Embodiments of the present inventive concept will be described more fully hereinafter with reference to the accompanying drawings. Like reference numerals may refer to like elements throughout the accompanying drawings.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

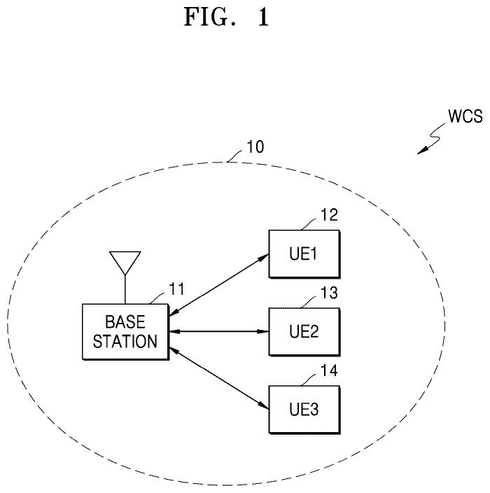

FIG. 1 is a block diagram illustrating a wireless communication system according to an embodiment.

Hereinafter, although embodiments of the inventive concept are described in accordance with new radio (NR) network-based wireless communication systems, particularly, 3GPP, the inventive concept is not limited to NR networks and may be applied to any other wireless communication systems including, for example, cellular communication systems, such as long-term evolution (LTE) systems, LTE-advanced (LTE-A) systems, wireless broadband (WiBro) systems, and global system for mobile communication (GSM) systems, or short-range communication systems including, for example, BLUETOOTH systems and near-field communication (NFC) systems, which have technical backgrounds or channel setting similar to NR systems.

In addition, various functions described below may be implemented or supported by artificial intelligence technology or by one or more computer programs, and each of the programs includes computer-readable program code and is implemented on a computer-readable medium. The terms “application” and “program” refer to one or more computer programs, software components, instruction sets, procedures, functions, objects, classes, instances, related data, or portions thereof suitable for the implementation of suitable computer-readable program code. The term “computer-readable program code” includes any types of computer code including source code, object code, and execution code. The term “computer-readable medium” includes any types of media, such as, for example, read-only memory (ROM), random access memory (RAM), hard disk drives, compact discs (CDs), digital video discs (DVDs), or any other types of memory, which may be accessed by computers. A “non-transitory” computer-readable medium does not include wired, wireless, optical, or other communication links for transmitting temporary electrical or other signals. Non-transitory computer-readable media include media in which data may be permanently stored, and media in which data may be stored and overwritten afterward, such as rewritable optical disks or erasable memory devices.

In embodiments described below, a hardware approach is described as an example. However, because embodiments of the inventive concept include a technique using both hardware and software, embodiments do not exclude software-based approaches.

Referring to FIG. 1, a wireless communication system WCS may include a base station 11, a first user equipment 12, a second user equipment 13, and a third user equipment 14. The base station 11 may generally refer to a fixed station communicating with the first to third user equipments 12, 13 and 14 and/or other base stations, and may exchange data and control information with the first to third user equipments 12, 13 and 14 and/or the other base stations by communicating therewith. For example, the base station 11 may be referred to as a cell, a Node B, an evolved-Node B (eNB), a next-generation Node B (gNB), a sector, a site, a base transceiver system (BTS), an access point (AP), a relay node, a remote radio head (RRH), a radio unit (RU), a small cell, a device, or the like. The base station 11 may provide wireless broadband access to the first to third user equipments 12, 13 and 14 within the coverage of the base station 11.

The first to third user equipments 12, 13 and 14 may refer to any types of equipment that are stationary or mobile and may transmit data and/or control information to and receive data and/or control information from the base station 11 by communicating with the base station 11. For example, each of the first to third user equipments 12, 13 and 14 may be referred to as a terminal, a terminal equipment device, a mobile station (MS), a mobile terminal (MT), a user terminal (UT), a subscribe station (SS), a wireless communication device, a wireless device, a handheld device, or the like. Although only the first to third user equipments 12, 13 and 14 are illustrated herein, the inventive concept is not limited thereto. For example, the wireless communication system WCS may include only some of the first to third user equipments 12, 13 and 14 or may further include other user equipments in addition to the first to third user equipments 12, 13 and 14.

The wireless communication system WCS may include a multiple-input and multiple-output (MIMO) communication system. For example, the base station 11 may include M antennas (where M is a positive integer of 2 or more), and the first user equipment 12 may include N antennas (where N is a positive integer of 2 or more). When the first user equipment 12 receives a reception signal while communicating with the base station 11, the reception signal may be represented by Equation 1 shown below.

$${y}_{j , f} = {G}_{R \times , j} \times ( {\sum }_{i = 1}^{M} ( {G}_{Tx , i} \times {h}_{i , j , f} \times {\sum }_{l = 1}^{L} {w}_{i , l , f} \times {x}_{l , f} ) + {n}_{th , f} + {\sum }_{k = 1}^{K} {I}_{k , j} ) \qquad [ Equation 1 ]$$

In Equation 1, y_{j,f} may refer to a reception signal in an f-th subcarrier in a j-th antenna among the N antennas of the first user equipment 12, and x_{l,f} may refer to a transmission signal in an f-th subcarrier in a first layer (or rank) of the base station 11. w_{i,l,f} may refer to a weight for beamforming (or precoding) to an i-th antenna among the M antennas of the base station 11, in an l-th layer in the f-th subcarrier, and L may refer to the number of layers. h_{i,j,f} may refer to a wireless channel between the i-th antenna among the M antennas of the base station 11 and the j-th antenna among the N antennas of the first user equipment 12, in the f-th subcarrier, and G_{Tx,i} may refer to a transmission gain that is a gain for adjusting transmission power in the i-th antenna among the M antennas of the base station 11. G_{Rx,j} may refer to a reception gain that is a gain for adjusting received power in a j-th antenna among the N antennas of the first user equipment 12, and n_{th,j} may refer to thermal noise of the j-th antenna among the N antennas of the first user equipment 12. I_{k,j} may refer to a reception signal, in the j-th antenna, of a k-th interference source among a plurality of interference sources, and K may refer to the number of interference sources. Σₖ₌₁^{K}I_{k,j} may be referred to as an interference signal. Referring to Equation 1, in the first user equipment 12, a signal-to-interference-plus-noise ratio (SINR) is proportional to the transmission gain (G_{Tx,i}). The SINR may refer to a value indicating a ratio of a reception signal to both noise and interference, for a reference signal.

In a wireless communication system in actual use, there may be internal noise, which is not included in Equation 1, in noise components of the first user equipment 12. As a result, when the first user equipment 12 receives a reception signal while communicating with the base station 11, because the internal noise is added to Equation 1, the reception signal may be represented by Equation 2 shown below.

$${y}_{j , f} = {G}_{R \times , j} \times ( {\sum }_{i = 1}^{M} ( {G}_{Tx , i} \times {h}_{i , j , f} \times {\sum }_{l = 1}^{L} {w}_{i , l , f} \times {x}_{l , f} ) + {n}_{th , f} + {\sum }_{k = 1}^{K} {I}_{k , j} ) + {n}_{Rx , j} \qquad [ Equation 2 ]$$

In Equation 2, n_{Rx,j} may refer to internal noise that is a noise component generated by internal circuits (for example, a mixer, an analog-to-digital converter (ADC), and the like) that are included in the first user equipment 12. In Equation 2, the noise components of the first user equipment 12 may be represented by Expression 1 shown below.

$${G}_{R \times , j} \times ( {n}_{th , f} + {\sum }_{k = 1}^{K} {I}_{k , j} ) + {n}_{Rx , j} \qquad [ Expression 1 ]$$

In Expression 1, because the reception gain (G_{Rx,j}) adjusts the received power to be at a certain level, when the received power is relatively large before the application of the reception gain (G_{Rx,j}), the magnitude of the reception gain (G_{Rx,j}) may be reduced, and the internal noise (n_{Rx,j}) among the noise components of the first user equipment 12 may be a dominant factor. Herein, a case in which the internal noise (n_{Rx,j}) among the noise components of the first user equipment 12 is a dominant factor may be referred to as a strong electric field, and a case in which thermal noise (n_{th,j}) or the interference signal (Σₖ₌₁^{K}I_{k,j}) rather than the internal noise (n_{Rx,j}) is a dominant factor may be referred to as a weak electric field.

In the strong electric field, even when the base station 11 increases the transmission power, reduces channel loss between the base station 11 and the first user equipment 12, or changes the transmission gain (G_{Tx,i}), due to the internal noise (n_{Rx,j}) that is proportional to the received power, the SINR in the first user equipment 12 may not be proportional to the transmission gain (G_{Tx,i}) unlike in Equation 1. For example, when the transmission gain (G_{Tx,i}) is greater than a threshold transmission gain, the SINR may be saturated such that the SINR converges at a specific value despite an increase in the transmission gain (G_{Tx,i}). The threshold transmission gain may refer to a gain causing the SINR to be saturated. In other words, in the weak electric field, the SINR may increase with the increasing transmission gain (G_{Tx,i}), and thus, communication performance may improve along with increasing power efficiency, whereas, in the strong electric field, the SINR may not increase along with the increasing transmission gain (G_{Tx,i}), and thus, a waste of power may occur and lead to a reduction in power efficiency and a deterioration in communication performance.

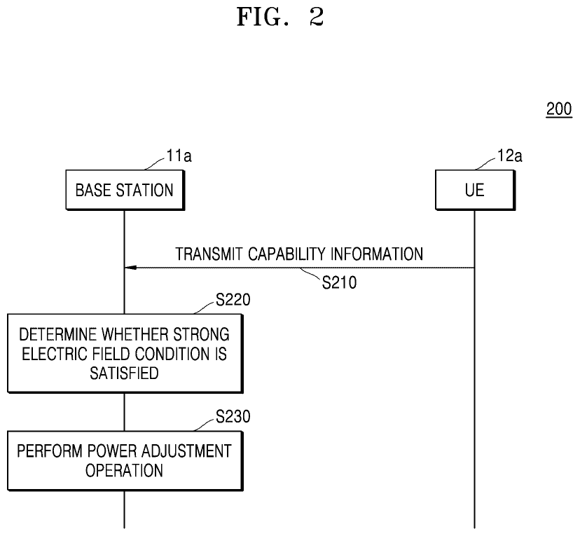

To address the above, the wireless communication system WCS according to embodiments of the inventive concept may determine whether internal noise among noise components of at least one of the first user equipment 12, the second user equipment 13, or the third user equipment 14 is a dominant factor, and may perform a power adjustment operation for adjusting transmission power of at least one of a signal or a channel transmitted by the base station 11 when the internal noise is a dominant factor As a result, wasted power may be reduced and power efficiency may be improved. Example embodiments, in which the wireless communication system WCS determines whether a strong electric field condition is satisfied, and performs a power adjustment operation when the strong electric field condition is satisfied, are described below with reference to FIGS. 2 to 9.

FIG. 2 is a flowchart illustrating a method of operating a wireless communication system, according to an embodiment.

Referring to FIG. 2, a method 200 of operating a wireless communication system may include a plurality of operations S210 to S230, and a base station 11a and a user equipment 12a may be examples of the base station 11 and the first user equipment 12 of FIG. 1, respectively. For convenience of explanation, a further description of components and technical aspects previously described with reference to FIG. 1 is omitted.

In operation S210, the user equipment 12a may transmit capability information to the base station 11a. In some embodiments, the capability information may include whether the user equipment 12a supports a determination parameter, and a determination parameter. The determination parameter refers to information allowing a distinction between the strong electric field and the weak electric field to be made. In some embodiments, the indication of whether the user equipment 12a supports the determination parameter may be omitted.

In operation S220, the base station 11a may determine whether a strong electric field condition is satisfied, based on the received capability information. In some embodiments, the base station 11a may determine whether internal noise among noise components of the user equipment 12a is a dominant factor, based on the determination parameter.

In some embodiments, the determination parameter may include a reference signal received power (RSRP) threshold corresponding to the user equipment 12a, and the base station 11a may compare RSRP of the user equipment 12a with the RSRP threshold and may determine the internal noise of the user equipment 12a to be a dominant factor, when the RSRP of the user equipment 12a is greater than the RSRP threshold. The RSRP of the user equipment 12a may be measured before and after operation S210, and the RSRP may refer to a value representing received power for a reference signal. The reference signal may include a synchronization signal block (SSB) or a channel state information-reference signal (CSI-RS). The RSRP threshold may refer to a reference value for determining the strong electric field and the weak electric field and may refer to a pre-calculated value, such as, for example, an experimental value, a simulated value, or a design target value.

In some embodiments, the determination parameter may include other parameters in addition to the RSRP threshold. For example, the determination parameter may include a threshold of reference signal received quality (RSRQ) or a threshold of received signal strength indicator (RSSI).

In some embodiments, the RSRP threshold may have a different value depending on a frequency band or a frequency bandwidth of a wireless communication system. For example, the RSRP threshold may have a different value when the frequency band or the frequency bandwidth is different, may have a value corresponding to a combination of the frequency band and the frequency bandwidth, or may be specified only regarding a minimum value or a maximum value of the RSRP threshold.

In some embodiments, the user equipment 12a may include a plurality of antennas, and the RSRP threshold either may include RSRP thresholds respectively corresponding to the plurality of antennas or may include an average of all the RSRP thresholds of the plurality of antennas.

For example, when the RSRP is defined as a linear average of the respective RSRPs of the plurality of antennas, the base station 11a may compare average RSRP of the plurality of antennas with an average RSRP threshold and may determine the internal noise of the user equipment 12a to be a dominant factor when the average RSRP is greater than the average RSRP threshold.

For example, when the respective RSRPs of the plurality of antennas may be estimated from the average RSRP, the base station 11a may compare the respective RSRPs of the plurality of antennas with the RSRP thresholds respectively corresponding to the plurality of antennas and may determine the internal noise to be a dominant factor, for antennas in which the RSRP is greater than the RSRP threshold. In other words, the base station 11a may determine whether the internal noise is a dominant factor, for each of the plurality of antennas of the user equipment 12a. A case in which the RSRP of each of the plurality of antennas may be estimated from the average RSRP may refer to a case in which the difference in received power or path loss between each of the plurality of antennas may be estimated by the antenna switching sounding reference signal (SRS) technique.

In some embodiments, the determination parameter may include a threshold ratio corresponding to the user equipment 12a, and the base station 11a may determine that the internal noise of the user equipment 12a is a dominant factor, when a ratio of the sum of the power of the interference signal and the power of the thermal noise to the power of the internal noise is less than the threshold ratio. The threshold ratio may be a pre-measured ratio, and the power of the internal noise may be pre-measured power. For example, the power of the internal noise may be pre-measured based on information regarding an automatic gain control (AGC) gain, the received power, and the frequency band of each antenna of the user equipment 12a and the like. The power of the thermal noise may be power measured inside the user equipment 12a. For example, the power of the thermal noise may be measured by using a temperature sensor of the user equipment 12a. The power of the interference signal may be estimated based on the internal noise and the thermal noise. For example, the power of the interference signal may be estimated as a value of power obtained by subtracting the power of the internal noise and the power of the thermal noise from an estimated value of power for all of the noise components of the user equipment 12a. The power of the interference signal may be estimated based on a reference signal specified in 3GPP.

In operation S230, the base station 11a may perform a power adjustment operation. The power adjustment operation may refer to an operation in which the base station 11a adjusts transmission power of at least one of a signal or a channel transmitted to the user equipment 12a.

In some embodiments, when the base station 11a determines in operation S220 that the internal noise among the noise components of the user equipment 12a is a dominant factor, the base station 11a may perform a power adjustment operation. When the internal noise among the noise components of the user equipment 12a is a dominant factor, that is, when the strong electric field condition is satisfied, because the SINR in the user equipment 12a is not proportional to the transmission gain even though the base station 11a changes the transmission gain, the base station 11a may adjust the transmission power of at least one of a signal or a channel transmitted to the user equipment 12a by adjusting the transmission gain and may reduce wasted power. As a result, power efficiency may be increased and the performance of communication with the user equipment 12a may be improved.

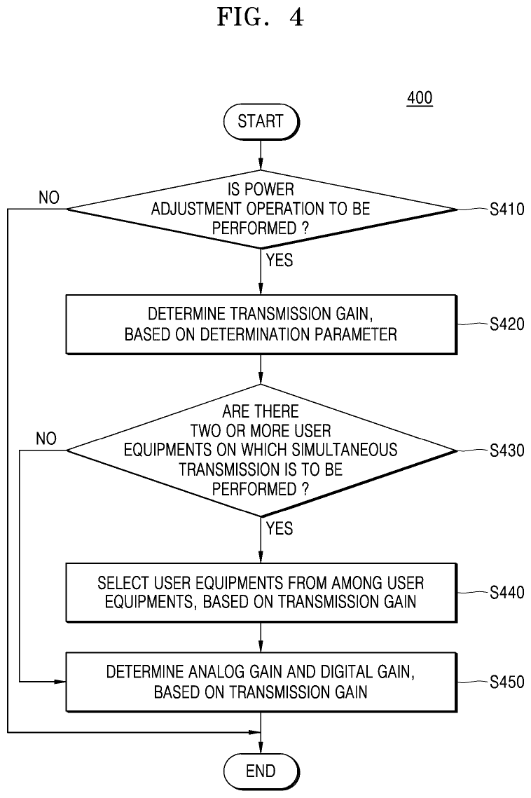

In some embodiments, when the base station 11a determines in operation S220 that the internal noise among the noise components of the user equipment 12a is not a dominant factor, the base station 11a does not perform a power adjustment operation. When the internal noise among the noise components of the user equipment 12a is not a dominant factor, that is, when the weak electric field condition is satisfied, because the SINR in the user equipment 12a is proportional to the transmission gain, the base station 11a may increase the SINR by increasing the transmission gain. As a result, power efficiency may be increased and the performance of communication with the user equipment 12a may be improved. Example embodiments, in which the base station 11a performs a power adjustment operation, are described below with reference to FIGS. 4 to 6.

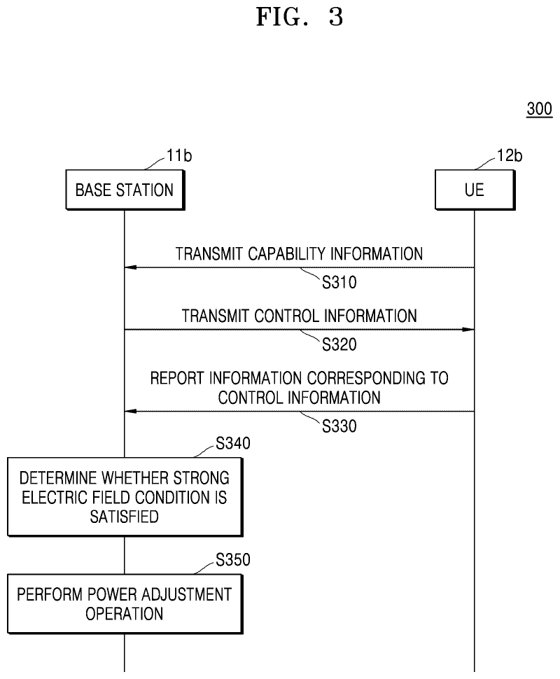

FIG. 3 is a flowchart illustrating a method of operating a wireless communication system, according to an embodiment.

Referring to FIG. 3, a method 300 of operating a wireless communication system may include a plurality of operations S310 to S350, and a base station 11b and a user equipment 12b may be examples of the base station 11 and the user equipment 12 of FIG. 1, respectively. For convenience of explanation, a further description of components and technical aspects previously described with reference to FIG. 1 is omitted.

In operation S310, the user equipment 12b may transmit capability information to the base station 11b. In some embodiments, the capability information may include whether the user equipment 12b supports a determination parameter, a determination parameter, and support information. The determination parameter refers to information allowing a distinction between the strong electric field and the weak electric field to be made, and may be the same as the determination parameter described with reference to FIG. 2. In some embodiments, the indication of whether the user equipment 12b supports the determination parameter may be omitted.

In some embodiments, the support information may include at least one of whether the user equipment 12b supports a non-periodic report, whether the user equipment 12b supports a report on each of a plurality of antennas of the user equipment 12b, whether the user equipment 12b supports a determination parameter related to the power of the interference signal, or whether the user equipment 12b supports a quick report.

In some embodiments, when the determination parameter includes an RSRP threshold corresponding to the user equipment 12b, a reference signal for measuring RSRP may include one of an SSB, a CSI-RS, and a physical downlink shared channel-demodulation reference signal (PDSCH-DMRS).

In operation S320, the base station 11b may transmit control information to the user equipment 12b. In some embodiments, the control information may include type information of information corresponding to the determination parameter. The base station 11b may receive the capability information including the determination parameter from the user equipment 12b and may transmit, to the user equipment 12b, the type information of the information corresponding to the determination parameter.

For example, when the determination parameter includes the RSRP threshold corresponding to the user equipment 12b, the type information of the information corresponding to the determination parameter may refer to information regarding the type of RSRP according to a reference signal for measuring RSRP. For example, the type information of the information corresponding to the determination parameter may include at least one of SS-RSRP that is RSRP measured based on an SSB, CSI-RSRP that is RSRP measured based on a CSI-RS, or PDSCH-DMSR RSRP that is RSRP measured based on a PDSCH-DMRS.

In some embodiments, the base station 11b may transmit the control information to the user equipment 12b by using at least one of, for example, radio resource control (RRC), a downlink control indicator (DCI), or a medium access control-control element (MAC-CE).

In some embodiments, when the capability information includes whether the user equipment 12b supports a non-periodic report, the control information may include the type information of the information corresponding to the determination parameter, and report timing information. The report timing information may refer to information regarding a reporting time point, including whether to perform reporting periodically or non-periodically, when the user equipment 12b reports to the base station 11b.

In operation S330, the user equipment 12b may report information corresponding to the control information to the base station 11b. In some embodiments, the user equipment 12b may report the information corresponding to the determination parameter, based on the type information of the information corresponding to the determination parameter.

For example, when the type information of the information corresponding to the determination parameter is SS-RSRP, the information corresponding to the determination parameter may be SS-RSRP measured in the user equipment 12b, when the type information of the information corresponding to the determination parameter is CSI-RSRP, the information corresponding to the determination parameter may be CSI-RSRP measured in the user equipment 12b, and when the type information of the information corresponding to the determination parameter is PDSCH-DMSR RSRP, the information corresponding to the determination parameter may be PDSCH-DMSR RSRP measured in the user equipment 12b.

In operation S340, the base station 11b may determine whether the strong electric field condition is satisfied, based on the received capability information and the information corresponding to the control information. In some embodiments, the RSRP of the user equipment 12a described with reference to FIG. 2 may be the same as the information corresponding to the control information, and operation S340 may be the same as operation S220 in FIG. 2. For convenience of explanation, a further description of components and technical aspects previously described with reference to FIG. 2 is omitted.

In operation S350, the base station 11b may perform a power adjustment operation. The power adjustment operation may refer to an operation in which the base station 11b adjusts transmission power of at least one of a signal or a channel transmitted to the user equipment 12b. In some embodiments, operation S350 may be the same as operation S230 of FIG. 2. For convenience of explanation, a further description of components and technical aspects previously described with reference to FIG. 2 is omitted.

FIG. 4 is a flowchart illustrating a power adjustment operation of a wireless communication system, according to an embodiment.

Referring to FIG. 4, a power adjustment operation 400 of a wireless communication system may include a plurality of operations S410 to S450.

Referring to FIGS. 1 and 4, in operation S410, the base station 11 may determine whether to perform a power adjustment operation. In some embodiments, when the base station 11 determines that the internal noise of at least one of the first to third user equipments 12, 13, and 14 is a dominant factor, the base station 11 may determine whether to perform a power adjustment operation, based on at least one of the number of user equipments communicating with the base station 11 or the number of user equipments in which the internal noise is a dominant factor. For example, in some embodiments, when the number of user equipments communicating with the base station 11 or the number of user equipments in which the internal noise is a dominant factor is greater than a threshold number of user equipments, the base station 11 does not perform a power adjustment operation, and when the number of user equipments communicating with the base station 11 or the number of user equipments in which the internal noise is a dominant factor is less than the threshold number of user equipments, the base station 11 may perform a power adjustment operation.

In some embodiments, the base station 11 may always perform a power adjustment operation when communicating with a user equipment in which the internal noise is a dominant factor, and in this case, operation S410 may be omitted.

In operation S420, the base station 11 may determine the transmission gain, based on the determination parameter. In some embodiments, the determination parameter may include an RSRP threshold corresponding to at least one of the first to third user equipments 12, 13, and 14, and the base station 11 may determine the transmission gain corresponding to at least one of the first to third user equipments 12, 13, and 14, based on RSRP of at least one of the first to third user equipments 12, 13, and 14 and the RSRP threshold.

For example, at least one of the first to third user equipments 12, 13, and 14 may include a plurality of antennas, and the RSRP of at least one of the first to third user equipments 12, 13, and 14 may include an average of all of the RSRPs of the plurality of antennas. The base station 11 may determine a transmission gain corresponding to at least one of the first to third user equipments 12, 13, and 14 by using Expression 2 shown below.

$$min \{ {arg min}_{Δ {G}_{Tx}} \{ {RSRP}_{Th} \times {RSRP}_{margin} \times {P}_{Ref , Comp} \leq {( Δ {G}_{Tx} )}^{2} \times {RSRP}_{report\_av} \} , 1 \} \qquad [ Expression 2 ]$$

ΔG_{Tx} may refer to a transmission gain corresponding to at least one of the first to third user equipments 12, 13, and 14 and may refer to a transmission gain commonly applied to each of the plurality of antennas. RSRP ₜₕ may refer to an average of all the RSRP thresholds of the plurality of antennas and may be a common RSRP threshold applied to each of the plurality of antennas. RSRP_{margin} may refer to a limit allowing the performance of communication between the base station 11 and at least one of the first to third user equipments 12, 13, and 14 not to deteriorate, when the transmission gain is adjusted to reduce wasted power. The limit (RSRP_{margin}) may be pre-calculated by taking into account a channel change for a period in which at least one of the first to third user equipments 12, 13, and 14 reports to the base station 11, a difference between the respective RSRPs of the plurality of antennas, a frequency axis channel change, an allowable range of performance deterioration of at least one of the first to third user equipments 12, 13, and 14, a difference in beamforming gain between a reference signal for RSRP estimation and a PDSCH, or the like. P_{Ref,Comp} may refer to a value for compensating for a difference in power between the reference signal for RSRP estimation and the PDSCH, and RSRP_{report_av} may refer to an average of all the RSRPs of the plurality of antennas.

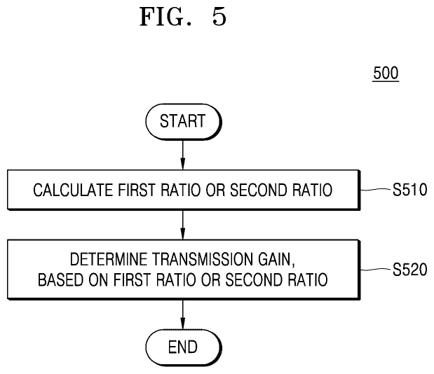

For example, at least one of the first to third user equipments 12, 13, and 14 may include a plurality of antennas, and the RSRP of at least one of the first to third user equipments 12, 13, and 14 may include RSRP corresponding to each of the plurality of antennas. Example embodiments of determining the transmission gain based on the RSRP corresponding to each of the plurality of antennas are described below with reference to FIG. 5.

In operation S430, the base station 11 may determine whether there are two or more user equipments to which at least one of a signals or a channel is to be simultaneously transmitted. In some embodiments, the base station 11 may perform operation S440 when there are two or more user equipments to which at least one of a signal or a channel is to be simultaneously transmitted through the division of resources in the frequence domain, and may perform operation S450 when there is one user equipment to which at least one of a signal or a channel is to be simultaneously transmitted through the division of resources in the frequence domain.

In operation S440, the base station 11 may select, based on the transmission gain, particular user equipments from user equipments to which at least one of a signal or a channel is to be simultaneously transmitted through the division of resources in the frequence domain. The base station 11 may communicate with the first to third user equipments 12, 13, and 14, and the first to third user equipments 12, 13, and 14 may be user equipments to which the base station 11 is to simultaneously transmit at least one of a signal or a channel through the division of resources in the frequence domain. Only when at least one of a signal or a channel, which is to be simultaneously transmitted through the division of resources in the frequence domain, has the same power or has power with a difference in a certain range, there may be no performance deterioration in a user equipment to which relatively lower transmission power is allocated. The channel may refer to a channel (for example, an SSB or a system information block1 (SIB1)) that is common to user equipments communicating with the base station 11.

In some embodiments, the base station 11 may compare the difference between the maximum transmission gain among the transmission gains of the first to third user equipments 12, 13, and 14 and an allowable gain with each of the transmission gains of the first to third user equipments 12, 13, and 14 and may select a user equipment having a transmission gain greater than the difference. For example, the base station 11 may select a user equipment satisfying Expression 3 shown below.

$$\{ ue \vert {G}_{Tx max} - {G}_{Tx , ue} \leq {G}_{max\_diff} \} \qquad [ Expression 3 ]$$

In Expression 3, G_{Tx,max} may refer to the maximum transmission gain among the transmission gains determined in operation S420, and G_{Tx,ue} may refer to a transmission gain of a user equipment. G_{max_diff} may refer to the maximum gain difference among the differences between gains allowing simultaneous transmission. The maximum gain difference (G_{max_diff}) may refer to a pre-calculated value. For example, when the first user equipment 12 and the second user equipment 13 each correspond to the user equipment satisfying Expression 3, the base station 11 may select, as the particular user equipments, the first user equipment 12 and the second user equipment 13 among the first to third user equipments 12, 13, and 14.

In some embodiments, the base station 11 may adjust the transmission gain such that all the first to third user equipments 12, 13, and 14 satisfy Expression 3. For example, the base station 11 may adjust the transmission gains of the first to third user equipments 12, 13, and 14 such that the transmission gain determined in operation S420 satisfies Expression 3 within a range satisfying Expression 2, and in operation S440, may select all of the first to third user equipments 12, 13, and 14 as the particular user equipments.

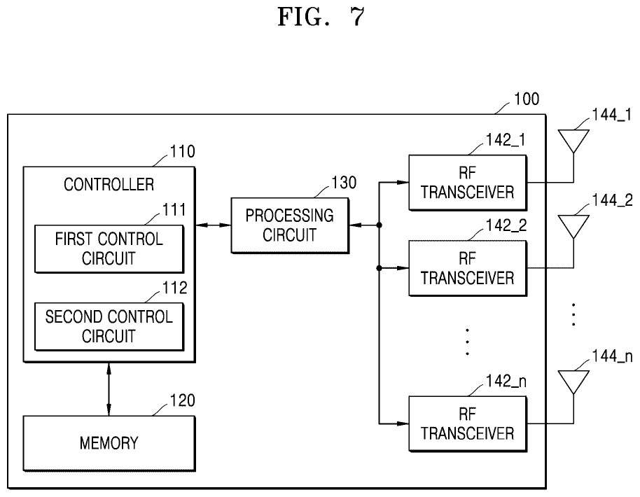

In operation S450, the base station 11 may determine an analog gain and a digital gain, based on the transmission gain. The analog gain may refer to a gain applied to a plurality of antennas of the base station 11, and the digital gain may refer to a gain applied before a digital-to-analog converter (DAC) of the base station 11. The DAC may refer to a device for converting a digital signal into an analog signal. Example embodiments regarding the analog gain and the digital gain are described below with reference to FIG. 7.

In some embodiments, the base station 11 may determine an analog gain commonly applied to the user equipments selected in operation S440 and may determine, as a digital gain, the difference between the transmission gain of each of the selected user equipments and the analog gain. In some embodiments, when the maximum gain difference (G_{max_diff}) is 0, the transmission gain of each of the selected user equipments may be the same, and the base station 11 may determine an analog gain commonly applied to the selected user equipments and may determine, as a digital gain, the difference between the analog gain and the transmission gain.

FIG. 5 is a flowchart illustrating an implementation example of determining a transmission gain of a wireless communication system, according to an embodiment.

Referring to FIG. 5, a method 500 of determining a transmission gain of a wireless communication system may include a plurality of operations S510 to S520 and may be an implementation example of operation S420 of FIG. 4.

Referring to FIGS. 1 and 5, in operation S510, the base station 11 may calculate a first ratio or a second ratio. The first ratio may refer to a ratio of the minimum RSRP among the RSRPs respectively corresponding to a plurality of antennas to an average of all the RSRPs of the plurality of antennas, and the second ratio may refer to ratios of the RSRPs respectively corresponding to the plurality of antennas to the average of all the RSRPs of the plurality of antennas. In some embodiments, the determination parameter may include an RSRP threshold corresponding to at least one of the first to third user equipments 12, 13, and 14, and at least one of the first to third user equipments 12, 13, and 14 may include a plurality of antennas. When the base station 11 is able to estimate the RSRP of each of the plurality of antennas from the average RSRP, the base station 11 may calculate the first ratio and the second ratio, based on the RSRP corresponding to each of the plurality of antennas and the RSRP threshold.

In operation S520, the base station 11 may determine the transmission gain, based on the first ratio or the second ratio. In some embodiments, the base station 11 may determine the transmission gain corresponding to at least one of the first to third user equipments 12, 13, and 14 by using Expression 4 shown below.

$$min \{ {arg min}_{Δ {G}_{Tx}} \{ {RSRP}_{Th} \times {RSRP}_{margin} \times {P}_{Ref , Comp} \leq {( Δ {G}_{Tx} )}^{2} \times \} {α}_{min} \times {RSRP}_{report} \} , 1 \} \qquad [ Expression 4 ]$$

In Expression 4, αₘᵢₙ may refer to a first ratio, and Expression 4 may be an expression modified from Expression 3 by taking into account the first ratio (αₘᵢₙ).

In some embodiments, the base station 11 may determine the transmission gain of each of the plurality of antennas corresponding to at least one of the first to third user equipments 12, 13, and 14 by using Expression 5 shown below.

$$min \{ {arg min}_{Δ {G}_{Tx}} \{ {RSRP}_{Th , j} \times {RSRP}_{margin} \times {P}_{Ref , Comp} \leq {( Δ {G}_{Tx} )}^{2} \times \} {α}_{j} \times {RSRP}_{report} \} , 1 \} \qquad [ Expression 5 ]$$

In Expression 5, αⱼ may refer to a second ratio corresponding to a j-th antenna among the plurality of antennas, and RSRP_{Th,j} may refer to an RSRP threshold corresponding to the j-th antenna among the plurality of antennas. Expression 5 may be an expression modified from Expression 3 by taking into account the second ratio (αⱼ).

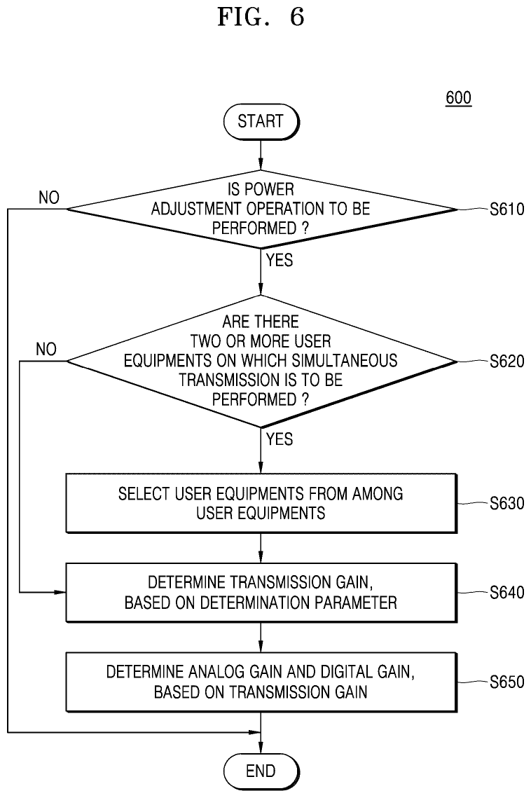

FIG. 6 is a flowchart illustrating an implementation example of a power adjustment operation of a wireless communication system, according to an embodiment.

Referring to FIG. 6, a power adjustment operation 600 of a wireless communication system may include a plurality of operations S610 to S650.

Referring to FIGS. 1 and 6, in operation S610, the base station 11 may determine whether to perform a power adjustment operation. In some embodiments, operation S610 may be the same as operation S410 of FIG. 4. For convenience of explanation, a further description of operations previously described with reference to FIG. 4 is omitted.

In operation S620, the base station 11 may determine whether there are two or more user equipments to which at least one of a signal or a channel is to be simultaneously transmitted. In some embodiments, the base station 11 may perform operation S630 when there are two or more user equipments to which at least one of a signal or a channel is to be simultaneously transmitted through the division of resources in the frequency domain, and may perform operation S650 when there is one user equipment to which at least one of a signal or a channel is to be simultaneously transmitted through the division of resources in the frequence domain.

In operation S630, the base station 11 may select particular user equipments from among user equipments to which at least one of a signal or a channel is to be simultaneously transmitted through the division of resources in the frequence domain. For example, the base station 11 may select the particular user equipments by a frequency division multiplexing (FDM) method or an orthogonal frequency division multiplexing (OFDM) method.

In operation S640, the base station 11 may determine a transmission gain of each of the selected user equipments, based on a determination parameter. In some embodiments, the operation of determining a transmission gain in operation S420 of FIG. 4 may also be applied to operation S640. For convenience of explanation, a further description of operations previously described with reference to FIG. 4 is omitted.

In operation S650, the base station 11 may determine an analog gain and a digital gain, based on the transmission gain. In some embodiments, operation S650 may be the same as operation S450 of FIG. 4. For convenience of explanation, a further description of operations previously described with reference to FIG. 4 is omitted.

FIG. 7 is a block diagram illustrating a base station of a wireless communication system, according to an embodiment. An implementation example of a base station 100 in FIG. 7 may also be applied to the base station 11 of FIG. 1.

The base station 100 may include a controller 110, a memory 120, a processing circuit 130, a plurality of RF transceivers 142_1 to 142_n, and a plurality of antennas 144_1 to 144_n, where n is a positive integer. The RF transceivers 142_1 to 142_n may respectively receive RF signals from the antennas 144_1 to 144_n, the RF signals being transmitted from a user equipment (for example, at least one of the first to third user equipments 12, 13, and 14 in FIG. 1) within coverage. The RF transceivers 142_1 to 142_n may respectively generate intermediate frequency (IF) or baseband signals by frequency-down-converting the received RF signals.

The controller 110 may additionally process data signals. In some embodiments, a program stored in the memory 120 and/or a process may be executed to perform all control operations on the base station 100.

The processing circuit 130 may generate data signals by filtering, decoding, and/or digitizing the IF or baseband signals, and the processing circuit 130 may receive data signals from the controller 110. The processing circuit 130 may encode, multiplex, and/or perform digital-to-analog conversion on the received data signals. The RF transceivers 142_1 to 142_n may respectively frequency-up-convert the IF or baseband signals, which are output from the processing circuit 130, and may respectively transmit the resulting signals as RF signals to a user equipment (for example, at least one of the first to third user equipments 12, 13, and 14) via the antennas 144_1 to 144_n.

In some embodiments, the controller 110 may control operations of the processing circuit 130, and the processing circuit 130 may determine whether a strong electric field condition is satisfied, based on capability information, and may perform a power adjustment operation when the strong electric field condition is satisfied.

For example, a first control circuit 111 of the controller 110 may transmit a first control signal that controls the processing circuit 130 to perform an operation of determining whether the strong electric field condition is satisfied, based on the capability information, and the processing circuit 130 may determine whether the strong electric field condition is satisfied, by performing operation S220 of FIG. 2 or operation S340 of FIG. 3 based on the first control signal.

For example, a second control circuit 112 of the controller 110 may transmit a second control signal that controls the processing circuit 130 to perform a power adjustment operation when the strong electric field condition is satisfied, and the processing circuit 130 may perform the power adjustment operation described above with reference to FIGS. 4 and 5, based on the second control signal.

In some embodiments, the processing circuit 130 may determine an analog gain and a digital gain, based on a transmission gain. The transmission gain may refer to the transmission gain determined in operation S420 of FIG. 4. For example, the second control circuit 112 of the controller 110 may transmit a third control signal that controls the processing circuit 130 to perform an operation of determining the analog gain and the digital gain, and the processing circuit 130 may determine the analog gain that is a gain applied to the antennas 144_1 to 144_n, based on the third control signal, and may determine, as the digital gain, the difference between the transmission gain of each of the user equipments selected in operation S440 of FIG. 4 and the determined analog gain. The digital gain may refer to a gain applied to a DAC of the processing circuit 130.

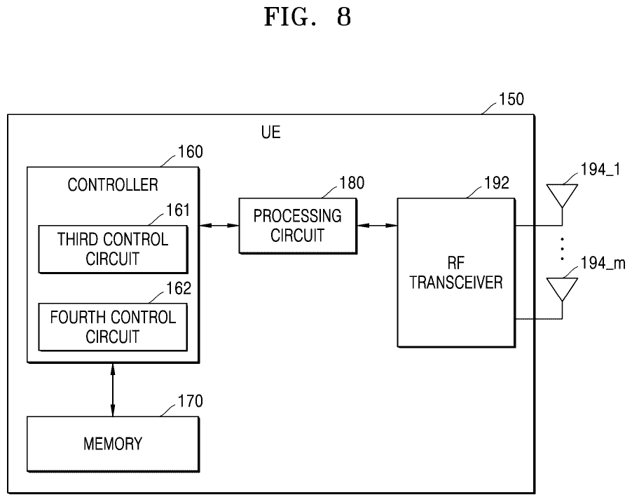

FIG. 8 is a block diagram illustrating a user equipment of a wireless communication system, according to an embodiment. An implementation example of a user equipment 150 in FIG. 8 may be applied to at least one of the first to third user equipments 12, 13, and 14 of FIG. 1.

The user equipment 150 may include a controller 160, a memory 170, a processing circuit 180, an RF transceiver 192, and a plurality of antennas 194_1 to 194_m, where m is a positive integer. The RF transceiver 192 may receive, via the antennas 194_1 to 194_m, RF signals transmitted by the base station 11 of FIG. 1. The RF transceiver 192 may generate IF or baseband signals by down-converting the received RF signals. The RF transceiver 192 may frequency-up-convert IF or baseband signals, which are output from the processing circuit 180, and may transmit the resulting signals as RF signals via the antennas 194_1 to 194_m.

The processing circuit 180 may generate data signals by filtering, decoding, and/or digitizing IF or baseband signals and may receive data signals from the controller 160. The processing circuit 180 may encode, multiplex, and/or perform analog-to-digital conversion on the received data signals.

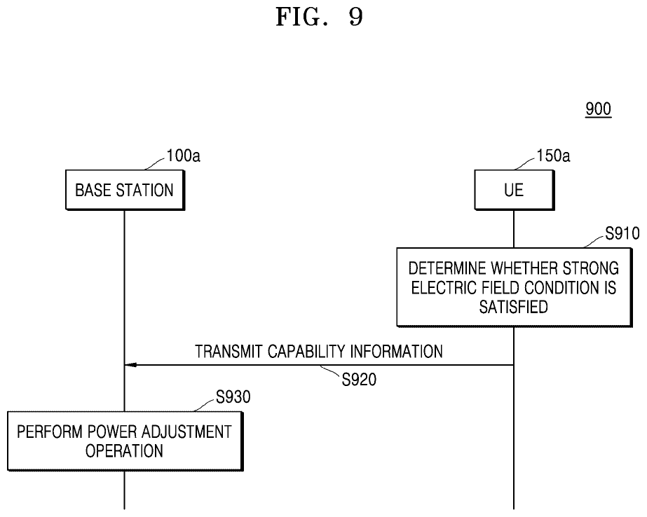

In some embodiments, the controller 160 may control operations of the processing circuit 180, and the processing circuit 180 may determine whether a strong electric field condition is satisfied, and when the strong electric field condition is satisfied, may generate capability information including power adjustment operation request information. For example, a third control circuit 161 of the controller 160 may generate a first control signal that controls an operation, performed by the processing circuit 180, of determining whether the strong electric field condition is satisfied, and the processing circuit 180 may determine whether the strong electric field condition is satisfied, based on the first control signal. For example, a fourth control circuit 162 of the controller 160 may generate a second control signal that controls an operation, performed by the processing circuit 180, of generating capability information, and the processing circuit 180 may generate the capability information including power adjustment operation request information, based on the second control signal. An example embodiment of the processing circuit 180 is described below with reference to FIG. 9.

The controller 160 may additionally process data signals and, to perform all control operations on the user equipment 150, may execute a program stored in the memory 170 and/or a process.

A look-up table may be stored in the memory 170. In some embodiments, the look-up table may be a look-up table corresponding to pre-measured power of internal noise of the user equipment 150. For example, the power of the internal noise may be pre-measured based on information regarding an AGC gain, received power, and a frequency band, for each antenna of the user equipment 150, and may be stored in the form of a look-up table in the memory 170. The controller 160 may transmit the look-up table stored in the memory 170 to the processing circuit 180, and the processing circuit 180 may determine whether the internal noise of the user equipment 150 is a dominant factor, based on the look-up table.

FIG. 9 is a flowchart illustrating a method of operating a wireless communication system, according to an embodiment.

Referring to FIG. 9, a method 900 of operating a wireless communication system may include a plurality of operations S910 to S930, and a base station 100a and a user equipment 150a may be examples of the base station 100 of FIG. 7 and the user equipment 150 of FIG. 8, respectively. For convenience of explanation, a further description of components and technical aspects previously described with reference to FIGS. 7 and 8 are omitted.

Referring to FIGS. 8 and 9, in operation S910, the user equipment 150a may determine whether a strong electric field condition is satisfied. In some embodiments, the processing circuit 180 of the user equipment 150a may determine whether internal noise among noise components of the user equipment 150a is a dominant factor, based on a determination parameter. The determination parameter may be the same as the determination parameter described above with reference to FIGS. 1 to 6. For example, the determination parameter may include an RSRP threshold corresponding to the user equipment 150a, and the processing circuit 180 may compare the RSRP threshold with the RSRP of the user equipment 150a and, when the RSRP of the user equipment 150a is greater than the RSRP threshold, may determine that the internal noise is a dominant factor.

In operation S920, the user equipment 150a may transmit capability information to the base station 100a. In some embodiments, when the user equipment 150a determines that the internal noise is a dominant factor, the user equipment 150a may transmit the capability information to the base station 100a. The capability information may include a power adjustment operation request information, and the power adjustment operation request information may be information for requesting the base station 100a to perform at least one of a first power adjustment operation or a second power adjustment operation. The first power adjustment operation may include an operation in which the base station 100a determines whether to perform the power adjustment operation described above with reference to FIGS. 1 to 6, determines a transmission gain corresponding to the user equipment 150a, based on the determination parameter, and determines an analog gain and a digital gain, which are applied to the user equipment 150a, based on the transmission gain. The second power adjustment operation may include an operation in which the base station 100a sequentially reduces the transmission gain corresponding to the user equipment 150a.

In operation S930, the base station 100a may perform a power adjustment operation. In some embodiments, the base station 100a may perform at least one of the first power adjustment operation or the second power adjustment operation, based on the power adjustment operation request information.

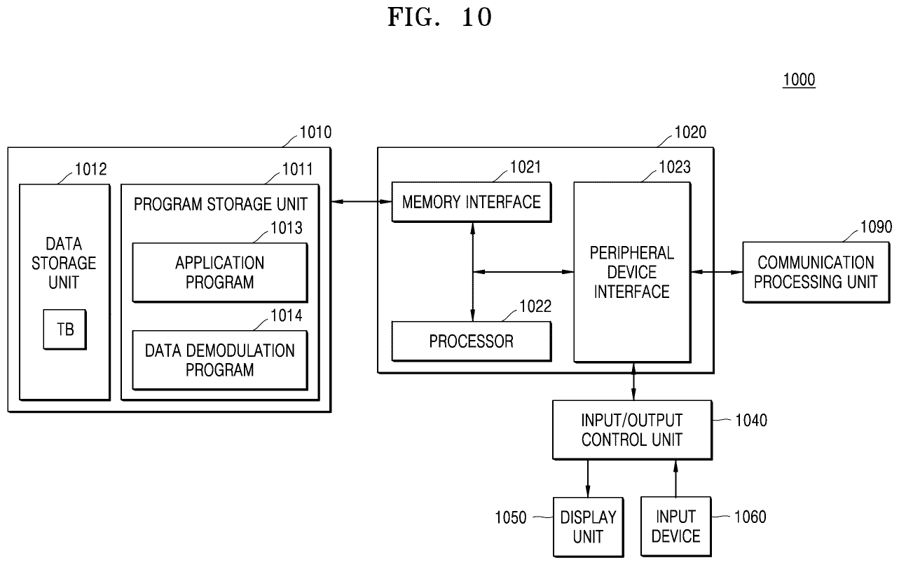

FIG. 10 is a block diagram illustrating an electronic device according to an embodiment. An electronic device 1000 may include a user equipment according to an embodiment.

Referring to FIG. 10, the electronic device 1000 may include a memory 1010, a processor unit 1020, an input/output control unit 1040, a display unit 1050, an input device 1060, and a communication processing unit 1090. Here, the memory 1010 may be one of a plurality of memories 1010.

The memory 1010 may include a program storage unit 1011 storing a program that controls operations of the electronic device 1000 and a data storage unit 1012 storing data generated during the execution of the program. The data storage unit 1012 may store data utilized for operations of an application program 1013 and a data demodulation program 1014 or may store data generated from the operations of the application program 1013 and the data demodulation program 1014. The data storage unit 1012 may store a look-up table TB, which is described with reference to FIGS. 2 and 8.

The program storage unit 1011 may include the application program 1013 and the data demodulation program 1014. Here, the program in the program storage unit 1011 is a set of instructions and may be referred to as an instruction set. The application program 1013 may include pieces of program code for performing various applications that operate on the electronic device 1000. That is, the application program 1013 may include pieces of code (or commands) regarding various applications driven by a processor 1022.

The electronic device 1000 may include the communication processing unit 1090 configured to perform a communication function for speech communication and data communication. A peripheral device interface 1023 may control connections between the input/output control unit 1040, the communication processing unit 1090, the processor 1022, and a memory interface 1021. By using at least one software program, the processor 1022 controls a plurality of base stations to provide a service corresponding to the software program. Here, by executing at least one program stored in the memory 1010, the processor 1022 may provide a service corresponding to the program.

The processor 1022 may determine whether a strong electric field condition is satisfied, as described above with reference to FIGS. 1 to 9, and when the strong electric field condition is satisfied, may perform a power adjustment operation for adjusting transmission power. As a result, wasted power may be reduced and power efficiency may be improved.

The input/output control unit 1040 may provide an interface between input/output devices, such as the display unit 1050 and the input device 1060, and the peripheral device interface 1023. The display unit 1050 displays, for example, station information, input characters, video, still pictures, and the like. For example, the display unit 1050 may display application information regarding applications driven by the processor 1022.

The input device 1060 may provide input data generated through selection by the electronic device 1000 to the processor unit 1020 via the input/output control unit 1040. Here, the input device 1060 may include, for example, a keypad including at least one hardware button, a touchpad for sensing touch information, and the like. For example, the input device 1060 may provide the touch information, such as a touch, a touch motion, or a touch release, which is sensed by the touchpad, to the processor 1022 via the input/output control unit 1040.

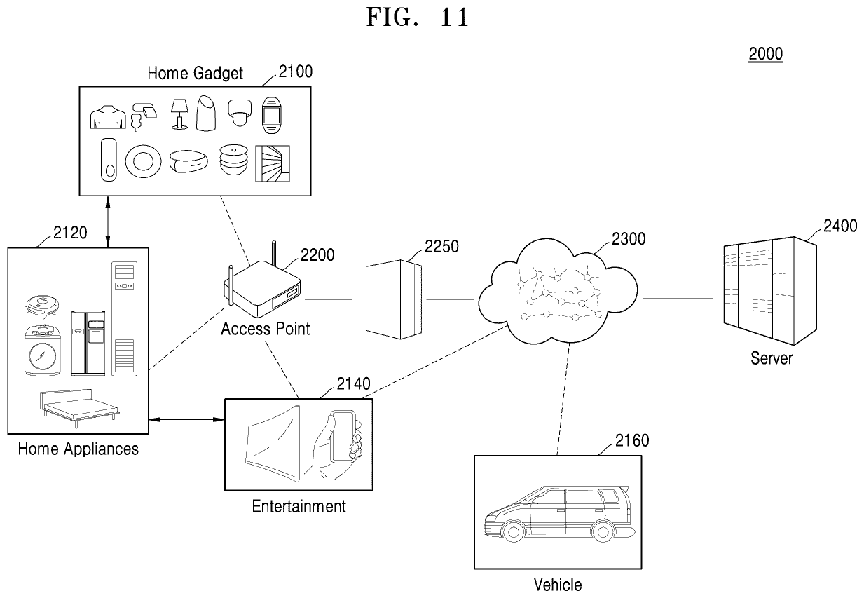

FIG. 11 is a conceptual diagram illustrating an Internet-of-Things (IoT) network system to which an embodiment is applied.

Referring to FIG. 11, an IoT network system 2000 may include a plurality of IoT devices (e.g., 2100, 2120, 2140, and 2160), an access point 2200, a gateway 2250, a wireless network 2300, and a server 2400. IoT may refer to a network between devices (referred to as things) using wired/wireless communication.

Each of the IoT devices (e.g., 2100, 2120, 2140, and 2160 may form a group, depending on characteristics of each IoT device. For example, the IoT devices may be grouped into a home gadget group 2100, a home appliance/furniture group 2120, an entertainment group 2140, a vehicle group 2160, or the like. A plurality of IoT devices (e.g., 2100, 2120, and 2140) may be connected to a communication network or another IoT device via the access point 2200. The access point 2200 may be embedded in one IoT device. The gateway 2250 may change a protocol such that the access point 2200 is connected to an external wireless network. The IoT devices (e.g., 2100, 2120, and 2140) may be connected to the external communication network via the gateway 2250. The wireless network 2300 may include the Internet and/or a public network. The plurality of IoT devices (e.g., 2100, 2120, 2140, and 2160) may be connected, via the wireless network 2300, to the server 2400 providing a certain service, and a user may use the service via at least one of the plurality of IoT devices (e.g., 2100, 2120, 2140, and 2160).

Each of the plurality of IoT devices (e.g., 2100, 2120, 2140, and 2160) may determine whether a strong electric field condition is satisfied, as described above with reference to FIGS. 1 to 9, and when the strong electric field condition is satisfied, may perform a power adjustment operation for adjusting transmission power. As a result, wasted power may be reduced and power efficiency may be improved.

As is traditional in the field of the inventive concept, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

While the inventive concept has been particularly shown and described with reference to embodiments thereof, it will be understood that various changes in form and detail may be made therein without departing from the spirit and scope of the inventive concept as defined by the following claims.

What is claimed is:

1. A method of operating a wireless communication system comprising a base station and at least one user equipment communicating with the base station, the method comprising:
receiving, by the base station, capability information comprising a determination parameter from the at least one user equipment;
determining, by the base station, whether an internal noise among noise components of the at least one user equipment is a dominant factor, based on the determination parameter; and
when the internal noise is determined to be the dominant factor, performing, by the base station, a power adjustment operation that adjusts a transmission power of at least one of a signal or a channel to be transmitted to the at least one user equipment.

2. The method of claim 1, wherein
the determination parameter comprises a reference signal received power (RSRP) threshold corresponding to the at least one user equipment, and
determining, by the base station, whether the internal noise among the noise components of the at least one user equipment is the dominant factor comprises,
when an RSRP of the at least one user equipment is greater than the RSRP threshold, determining, by the base station, that the internal noise is the dominant factor.

3. The method of claim 2, wherein
the RSRP threshold has a different value depending on a frequency band or a frequency bandwidth of the wireless communication system.

4. The method of claim 2, wherein
the at least one user equipment comprises a plurality of antennas, and
the RSRP threshold comprises a plurality of RSRP thresholds, which respectively correspond to the plurality of antennas, or an average of all of the RSRP thresholds of the plurality of antennas.

5. The method of claim 2, wherein
the RSRP of the at least one user equipment is measured based on one of a synchronization signal block (SSB), a channel state information-reference signal (CSI-RS), or a physical downlink shared channel-demodulation reference signal (PDSCH-DMRS).

6. The method of claim 1, wherein
the determination parameter comprises a threshold ratio corresponding to the at least one user equipment,
determining, by the base station, whether the internal noise among the noise components of the at least one user equipment is the dominant factor comprises, when a ratio of a sum of power of an interference signal and power of a thermal noise to power of the internal noise is less than the threshold ratio, determining, by the base station, that the internal noise is the dominant factor, and
the noise components of the at least one user equipment further comprise the interference signal and the thermal noise.

7. The method of claim 1, wherein
the capability information further comprises information regarding whether the at least one user equipment supports a non-periodic report, and
determining, by the base station, whether the internal noise among the noise components of the at least one user equipment is the dominant factor comprises:
when the at least one user equipment supports the non-periodic report, transmitting, by the base station, report timing information to the at least one user equipment;
non-periodically or periodically reporting, by the at least one user equipment, information corresponding to the determination parameter; and
determining, by the base station, whether the internal noise among the noise components of the at least one user equipment is the dominant factor, based on the determination parameter and the information corresponding to the determination parameter.

8. The method of claim 1, wherein
the determination parameter comprises a reference signal received power (RSRP) threshold corresponding to the at least one user equipment, and
performing, by the base station, the power adjustment operation comprises:
determining a transmission gain corresponding to the at least one user equipment, based on an RSRP of the at least one user equipment and the RSRP threshold;
when the at least one user equipment comprises two or more user equipments, selecting, from the two or more user equipments, user equipments on which simultaneous transmission is to be performed by dividing resources in a frequency domain; and
determining an analog gain commonly applied to the selected user equipments and a digital gain corresponding to each of the selected user equipments, based on the transmission gain.

9. The method of claim 8, wherein
the at least one user equipment comprises a plurality of antennas,
the RSRP of the at least one user equipment comprises an average of all RSRPs of the plurality of antennas, and
the RSRP threshold comprises an average of all RSRP thresholds of the plurality of antennas.

10. The method of claim 8, wherein
the at least one user equipment comprises a plurality of antennas,
the RSRP of the at least one user equipment comprises RSRPs respectively corresponding to the plurality of antennas,
the RSRP threshold comprises RSRP thresholds respectively corresponding to the plurality of antennas,
determining the transmission gain comprises:
calculating at least one of a first ratio or a second ratio; and
determining the transmission gain, based on at least one of the first ratio or the second ratio,
the first ratio comprises a ratio of a minimum RSRP among the RSRPs to an average of all of the RSRPs of the plurality of antennas, and
the second ratio comprises a ratio of the RSRP corresponding to each of the plurality of antennas to the average of all of the RSRPs of the plurality of antennas.

11. The method of claim 8, wherein
selecting the user equipments comprises:
selecting, from two or more user equipment, user equipments for which the transmission gain is determined to be equal to or greater than a difference between a maximum transmission gain among the transmission gains and an allowable gain.

12. The method of claim 8, wherein
determining, by the base station, whether the internal noise among the noise components of the at least one user equipment is the dominant factor comprises:
determining, by the base station, whether to perform the power adjustment operation, based on at least one of a number of user equipments, which are included in the two or more user equipments, or a number of user equipments in which the internal noise is the dominant factor, out of the two or more user equipments.

13. The method of claim 1, wherein
the determination parameter comprises a reference signal received power (RSRP) threshold corresponding to the at least one user equipment,
performing, by the base station, the power adjustment operation comprises:
determining whether to perform the power adjustment operation;
when the at least one user equipment comprises two or more user equipments, selecting, from the two or more user equipments, user equipments on which simultaneous transmission is to be performed by dividing resources in a frequency domain;
determining a transmission gain corresponding to each of the selected user equipments, based on an RSRP of each of the selected user equipments and the RSRP threshold; and
determining an analog gain commonly applied to the selected user equipments and a digital gain corresponding to each of the selected user equipments, based on the transmission gain.

14. A method of operating a base station communicating with at least one user equipment, the method comprising:
receiving, from the at least one user equipment, capability information comprising a determination parameter and power adjustment operation-related information;
requesting information corresponding to the determination parameter from the at least one user equipment, based on the capability information;
receiving the information corresponding to the determination parameter;
determining whether an internal noise among noise components of the at least one user equipment is a dominant factor, based on the determination parameter and the information corresponding to the determination parameter; and
when the internal noise is determined to be the dominant factor, performing a power adjustment operation that adjusts a transmission power of at least one of a signal or a channel transmitted to the at least one user equipment.

15. The method of claim 14, wherein
the at least one user equipment comprises a plurality of antennas, and
the power adjustment operation-related information comprises:
at least one of information indicating whether the at least one user equipment supports a non-periodic report or information indicating whether the at least one user equipment supports a report on each of the plurality of antennas.

16. The method of claim 15, wherein
requesting the information corresponding to the determination parameter from the at least one user equipment, based on the capability information, comprises:
when the at least one user equipment supports a non-periodic report, requesting report timing information from the at least one user equipment, and
receiving the information corresponding to the determination parameter comprises:
non-periodically or periodically receiving the information corresponding to the determination parameter, based on the report timing information.

17. The method of claim 15, wherein
the determination parameter comprises a reference signal received power (RSRP) threshold corresponding to the at least one user equipment,
performing the power adjustment operation comprises:
determining whether to perform the power adjustment operation;
determining a transmission gain corresponding to the at least one user equipment, based on an RSRP of the at least one user equipment and the RSRP threshold;
when the at least one user equipment comprises two or more user equipments, selecting, from the two or more user equipments, user equipments on which simultaneous transmission is to be performed by dividing resources in a frequency domain; and
determining an analog gain commonly applied to the selected user equipments and a digital gain corresponding to each of the selected user equipments, based on the transmission gain, and
determining the transmission gain comprises:
when the report on each of the plurality of antennas is supported, determining the transmission gain, based on RSRPs respectively corresponding to the plurality of antennas and RSRP thresholds respectively corresponding to the plurality of antennas; and
when the report on each of the plurality of antennas is not supported, determining the transmission gain, based on an average of all of the RSRPs of the plurality of antennas and an average of all of the RSRP thresholds of the plurality of antennas.

18. A user equipment configured to perform wireless communication with a base station, the user equipment comprising:
a plurality of antennas; and
a processing circuit configured to determine whether an internal noise among noise components of the user equipment is a dominant factor, based on a determination parameter, and, when the internal noise is determined to be the dominant factor, generate capability information comprising power adjustment operation request information.

19. The user equipment of claim 18, wherein
the determination parameter comprises one of a reference signal received power (RSRP) threshold, which corresponds to each of the plurality of antennas, and an average of all of the RSRP thresholds of the plurality of antennas, and
the processing circuit is further configured to determine the internal noise to be the dominant factor, either when an RSRP corresponding to each of the plurality of antennas is greater than the RSRP threshold or when an average of all of the RSRPs of the plurality of antennas is greater than the average of all of the RSRP thresholds of the plurality of antennas.

20. The user equipment of claim 18, wherein
the power adjustment operation request information comprises information for requesting to perform at least one of a first power adjustment operation or a second power adjustment operation that adjusts a transmission power of at least one of a signal or a channel transmitted to the user equipment by the base station,
the first power adjustment operation comprises:
an operation in which the base station determines whether to perform a power adjustment operation, determines a transmission gain corresponding to the user equipment, based on the determination parameter, and determines an analog gain and a digital gain, which are applied to the user equipment, based on the transmission gain, and
the second power adjustment operation comprises:
an operation in which the base station sequentially reduces the transmission gain corresponding to the user equipment.
